(19) United States
(12) Patent Application Publication
(10) Pub. No.: US 2019/0299696 A1
(43) Pub. Date: Oct. 3, 2019

(54) Scratch Off Ink Customizable Greeting Cards

(71) Applicant: Amanda M O'Malley, York Beach, ME (US)

(72) Inventor: Amanda M O'Malley, York Beach, ME (US)

(21) Appl. No.: 16/051,484

(22) Filed: Aug. 1, 2018

Related U.S. Application Data
(60) Provisional application No. 62/536,497, filed on Jul. 25, 2017.

(51) Int. Cl. B42D 15/04; G09F 1/04

(52) U.S. Cl. CPC B42D 15/042; G09F 1/04

(57) ABSTRACT

Present invention relates to a piece of writable material such as a Greeting Card, invitation, post card, gift tag and the like, particularly to customizable greeting cards, wherein on at least one surface there is provided a customizable zones with a removable layer to write personalized text.

A user of the product simply enters information on designated customizable zones using a hard-edged item, eliminating the need for a standard writing utensil, and achieving the look of a professionally printed card.

### CROSS-REFERENCE TO RELATED APPLICATIONS

This application claims the benefit of provisional patent application Ser. No. 62/536,497 filed 2017 Jul. 25 by the present inventor.

### BACKGROUND

### Prior Art

The following is a tabulation of some prior art that presently appears relevant: U.S. Pat. No. 5,257,823A, Personalized paper product and method, 1993, 8 Feb., Papercrafters Inc. U.S. Pat. No. 5,815,964, Hidden message greeting card, 1998, 6 Oct., Roy Douglas

U.S. Pat. No. 5,829,790, Greeting card kit having associated adhesive labels or stickers for customized greeting cards, 1998, 3 Nov., Richard Phillips

US2011/0016757A1, Greeting card, 2011, 27 Jan., James Beckett

UK2494224, A greeting card and associated system/greeting card with scratch-off area, 2012, 3 May

Currently there are a number of solutions for customizing Greeting Cards. Some of the solutions attempts to include pre-printed stickers, online templates, in store customizable machine stations, hidden custom messages, create your own message using individual letter and number pieces, and print at home card kits, but none offer a simple and easy on the go solutions for custom cards.

Many types of greeting cards for many different events or occasions are well known and exchanged throughout the world. Currently manufactures provide pre-printed greeting cards for a variety of occasions. However, these cards are mass-produced, as such are not personalized.

Greeting card kiosks are available in some stores for customers to print customized cards however this can take a lot of time to design, offer few options and the cost to maintain the machines add to the cost of the card.

Customized greeting card kits offer a preprinted card accompanied by a sheet of stickers, each offering an alternate name to display on the card. However, these kits provide limited names and the majority of the stickers go unused creating waste.

Some solutions offer interactive greeting cards with whereby the sender of the card writes a custom message that is concealed by means of scratch off ink, or scratch off ink stickers that the recipient then scratches away to reveal the senders message, however the custom message is a normally in a form of a question or is a secret answer and this does not provide a personalized card that celebrates the receiver.

Still other solutions seek to offer customizable cards with a plurality of individual puzzle like letters and numbers to create a custom message on the face of the card, however this solution must offer multiples of each letter and number, and the cost of this adds to the cost of the card and the majority of the pieces go unused creating waste.

Still other solutions seek to offer cards that can be produced on personal computers connected to printers at home. These cards have minimum details and are not capable of achieving a professional printed finish.

There is a need for a greeting card with preprinted illustrations and text that has a unique construction which can quickly and easily be personalized by the sender, appears as though it was professionally manufactured, produces zero waste, and is more economic than current customized cards.

### SUMMARY

In accordance with one embodiment a card comprises a sheet of writable material, provided with a preprinted design and preprinted text, having a removable coating to create text. In accordance with one embodiment a single piece of writable material such as a greeting card, post card, invitation, gift tag & the like, is provided having preprinted text, one or more customizable zones, comprising of having areas of printed matter, hidden by an opaque removable coating, the sender adds the personalized text of choosing by selectively removing said opaque coating by means of a hard-edged implement, thereby creating a custom message when displayed in combination with the other printed matter.

### BRIEF DESCRIPTION OF DRAWINGS

FIG. 1 shows a front view of the greeting cards face panel, according to one embodiment;

FIG. 2a and FIG. 2b shows a front view of the greeting cards interior panels, according to one embodiment; FIGS. 3a and 3b and 3c and 3d show a front view of the greeting card panels illustrating printed matter represented by patterns according to one embodiment;

FIGS. 4a and 4b shows a personalized card according to one embodiment;

FIG. 5 shows a wooden stylus according to one embodiments;

FIGS. 6a, 6b, 6c, and 6d shows a before and after of alternate embodiments;

FIG. 7 shows a legend for identifying printed matter represented by patterns according to one embodiment;

FIG. 8, 9 are front views illustrating various aspects of multiple panels, according to one embodiments;

DRAWINGS-REFERENCE NUMERALS

| | |
|---|---|
| 11 card structure | 12 rear interior panel |
| 13 fold | 14 face panel |
| 15 interior face panel | 16 preprinted text |
| 18 customizable zones | 19 design layer |
| 20 background layer | 30 release coating |
| 32 removable layer | 34 removable design layer |
| 52 stylus angled end | |

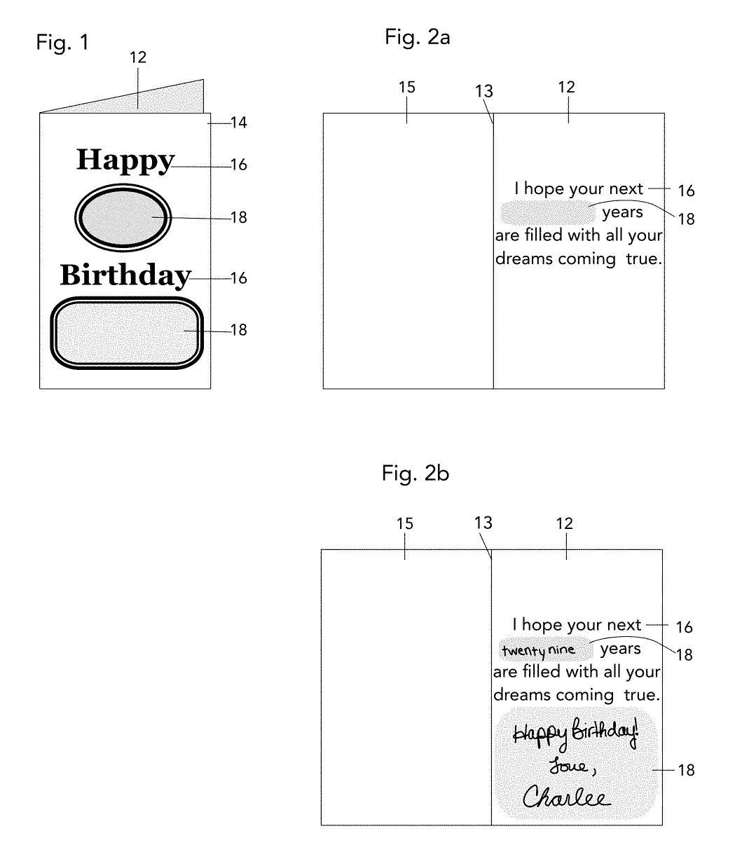

### DETAILED DESCRIPTION FIG. 1, 2A, 2B, 3A, 3D, 3C, 3D, 4A AND 4B

### First Embodiment

Referring now to the drawings in which like referenced characters indicate corresponding elements throughout the several views, there is shown one preferred embodiment of the greeting card kit provided for illustrative purposes only and not to be construed in any limiting sense.

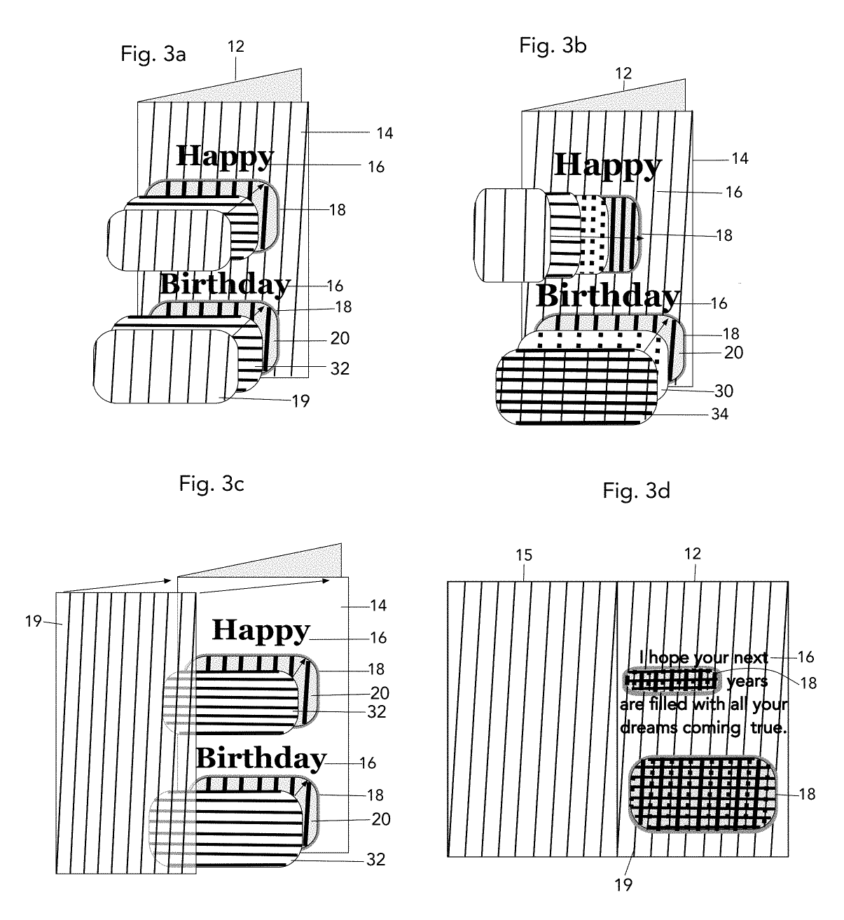

FIGS. 1 and 2a illustrates one embodiment of the customizable card showing a front view of the card (FIG. 1) and interior view (FIG. 2a) of the same card, comprised from a single sheet or paneled sheets of writable material such as card stock or a paper like material, as is well known in the art, makes up the cards structure 11. Single sheets may be divided by a fold, 13 and paneled sheets may be coupled to form the fold. Preferably the fold 13 is a crease formed by folding the paper in half, creating a live hinge 13 connecting the face panel 14 and rear panel 12 allowing the two sides to open and close like a book. The size of the panels can be any size and shape but most often a standard greeting card size or the like is desired.

According to one embodiment the panels of the card: the face panel 14 and the interior sides of the panels of the card, the interior of the face panel 15 and the interior of the rear panel, 12 may have whatever preprinted design 19 and text 16 applied to their surfaces. The preprinted elements 19 and 16 can be applied to the card by any printing process or by other means necessary, be it, by hand or machine. The preprinted text 16 in FIG. 1. conveys a conventional happy birthday message or wish, thereby creating a template for the sender to customize. While this may be one typical application of one embodiment it is nonetheless intended merely as an example of one of the many potential uses.

The preprinted elements; preprinted text, 16 and design elements, 19 create the design and theme of the card. They add the colors, images, illustrative text, patterns, associated materials, illustrations, photos, decorations and any other accessories commonly seen on professionally manufactured greeting cards. This design layer 19 can be applied multiple times in sections, multiple times to the entire card, all at once, and whatever process and steps are necessary to achieve the outcome of the cards overall design.

In addition to the preprinted matter 16 and 19 there are customizable zones 18 in one or more spots that are configured throughout the card. The zones 18 provide a means for adding personalized text, and the placement of the zones can be designated by the preprinted text 16 voids, identifying precisely where the sender may enter the personalized information. The sender adds personalized information by selectively removing layers the within the customizable zones to write the personalized text of their choice.

The layers that make up these zones 18 can be applied to the cards structure 16 by a printing process, by hand or by machinery. The zones 18 can blend into the card design, or the zones 18 may be highlighted, outlined or colored in, in a way that makes it a noticeable feature.

The interior of the card shown in FIG. 2a shows one embodiment with a customizable zone 18 placed among the preprinted text 16 on the interior panel, 12 allowing the interior message to include custom information related to the information entered on the face panel 14. FIG. 2b shows an alternative embodiment of the same card shown in FIG. 1 with a customizable zone 18 located below the interior preprinted message, 16 which is typically the place where the sender adds a signature. The addition of this customizable zone allows the greeting card to be completely personalized by the sender without the use of conventional writing utensils.

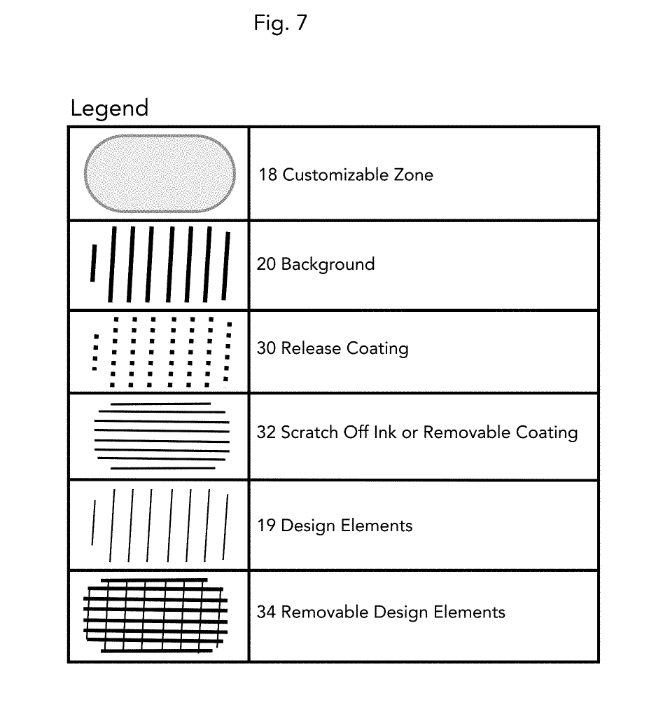

FIGS. 3a and 3b shows the same card as in FIG. 1. These images illustrate the elements applied to the card such as printed matter, 16 any details added to establish the overall design, 19 and the layers that make up the customizable zones, 18 each one represented by a pattern, refer to the legend in FIG. 7. The customizable zones 18 layers are sections of assorted patterns overlapping one another, and arranged as such, as if transcending towards the surface of the card. The order in which the layers are applied, is represented by the directional arrow pointing from the top layer, to the surface of the card where they all are applied. Each element that makes up the card can be built on or around the other and can be applied in various orders, some which may not be shown.

According to one embodiment FIGS. 3a, 3b, and 3c shows the base layer 20, otherwise referred to as the background layer, 20 this layer can be any media, image, text, illustration, color or design including but is not limited to; foils. glitter, flitter, faux glitter, neon colors, photos, glow in the dark, iridescent and holographic foils. This background layer 20 should be an adequate substance or substrate that provides a surface that can retain the layering necessary to create the customizable zones, 18 and withstand the scratching action when the other layers are removed. Additional substances can be added to assist the rigidity of the background layer and may not be illustrated. The color of this layer 20 is the color of the custom text the sender adds, and therefore this color should contrast with adjacent colors, those being the color or colors of the layers 32, and 19 applied onto the background 20. Since the coloring of the background layer 20 is the coloring of the custom text, matching or coordinating this layer with the preprinted text 18 will achieve professional looking results.

An example of this would be; a card with preprinted 18 gold foil lettering, and gold foil substrate is used for the background layer, 20 the personalized text the sender adds to the card would result in being that of gold foil, thereby matching the preprinted 18 lettering, achieving a custom look that was professionally printed.

FIGS. 3a, 3b and 3c illustrates the second layer which is a removable layer 32 or scratch off ink layer that may be sandwiched between the background layer 20 and the final design layer, 19 or sandwiched between a release coating layer 30 and the design layer 19, or it may be the final layer with nothing else applied onto it. The release coating may be any substance or coating that is adapted to be easily removed without defacing the background and is opaque in nature in order to hide the underlying background media from showing through. A substance well known in the art is referred to as scratch off ink and can be used to cover the background layer 20.

The removable layer 32 can be the combination of one or more layers, as well as it may need assistance from additional layers or other components and those may not be illustrated. When the design layer 19 is adapted to be easily removed, the specific scratch off ink component is not required and the design layer 19 takes the place of the scratch off ink, thereby becoming the removable design layer 34, and vice versa; if the scratch off ink substance used is capable of display the correct coloring or say glitter, then the removable scratch off ink coating is also the design layer, 34 omitting the need for the additional applications. FIG. 3b illustrates the removable layer 32 and the design layer, 19 blended as one layer 34. This layer, along with the layers that may be applied onto it, will be removed to create the custom text.

The final layer for the customizable zones 18 is the design layer 19 this layer is applied on the areas where the removable coating or scratch off ink is applied. This layer may be the same elements that are applied to the surrounding surfaces of the card, thereby coordinating the customizable zone 18 with the rest of the card and adding designs that works with the overall design of the card.

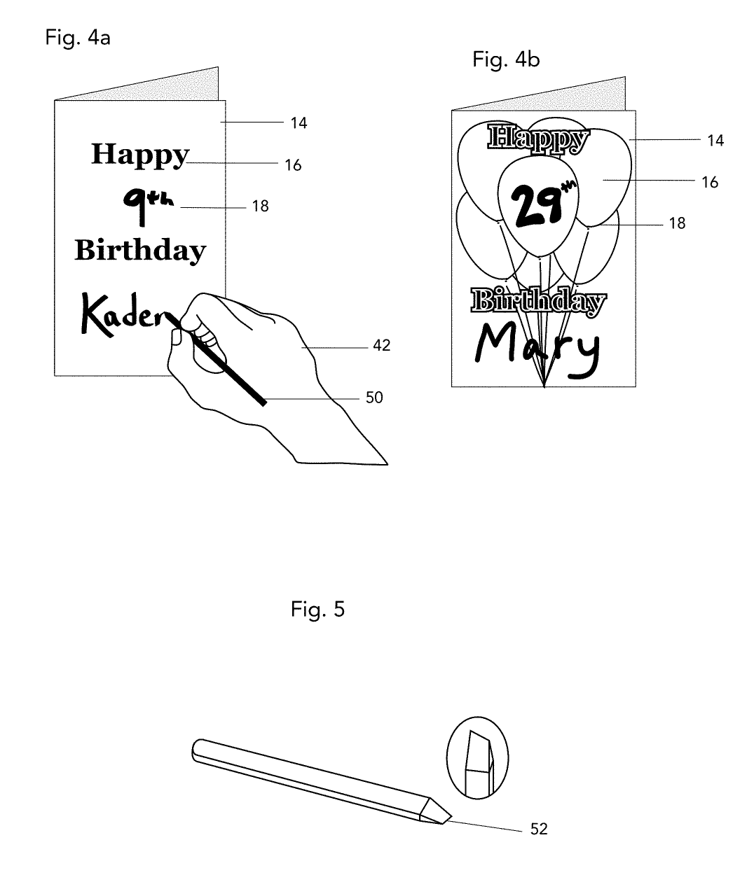

The design layer 19 a cosmetic layer, contributes to the look of the customizable zones 18 in many ways particularly to the color, including white or matching the color of the cards surroundings, and continuing an image as if the zone wasn't there, shown in FIGS. 4a and 4b. Esthetically this aids the zones 18 with blending in with the rest of the card. i.e. an image overlaps onto the zone 18, or outlining the zones 18 creating boarders, distinctively marking where the customizable areas are shown in FIG. 1. Having them stand out as a feature.

FIG. 3b shows the same card as 3a illustrating one embodiment with an additional layer that can be added to the customizable zones 18. This layer is referred to as the release coating layer 30 and it can be added to assist removability of the layers that are applied to the background layer, 20 when it's needed. The release coating 30 can be any substance that aids in the removing of other layers including but not limited to substances such as waxes and films. The release coating 30 can also be the scratch off ink layer as it aids other substances to be removed. Certain instances may call for this layer when the scratch off ink may need assistance depending on the material and substance used for other layers.

The matter that makes-up the layers of the customizable zones 18 can be any type of printed matter or coating that gives the desired results and attributes that are required by each layer to ultimately supply; a removable matter with designer elements, that the sender then rubs away to reveals a substrate 20 to create the text, which coordinated with the preprinted text 16.

FIGS. 4a and 4b shows the same card in FIG. 1, 2, 3a, 3b, 3c, and illustrates the sender demonstrating the process of customizing the card and the end results achieved by using a stylus 52 to write in the customizable zones. The custom text the sender added along with the preprinted text now reads happy 9th birthday Kaden. The sender added the numerals and letters; 9th and the name; Kaden in the text voids on the card by selectively removing some of the substances that make up these customizable zones. FIG. 4b reads; happy 29th birthday Mary. Same theme, same occasion, two totally different age ranges can be achieved from one style of card.

Illustrated in FIG. 5 is what is commonly referred to as a wooden stylus. A stylus such as this is commonly used to remove scratch off ink and is used as a tool to remove the layer or layers in the customizable zones 18. One end of the stylus has a pointed angled flat edge that is used to remove the coatings. One embodiment illustrates the wooden stylus being one that is flat and wider like the shape of a popsicle stick with a pointed angled end and a rounded end. This offers alternate tips to aid the user in removal from one stylus. The inclusion of a flat stylus such as this, is for the purpose of making it easier to supply one with the card and have it stored in the cards packaging, including everything needed in one convenient customizable kit.

### Operation FIGS. 1, 2A, 2B, 3A, 3D, 3C, 3D, 4A and 4B

The manner of acquiring a customizable greeting card is identical to buying a card presently. One would go to a store that sells greeting cards and purchase a card with the theme they desire. Then one would open the card encased in clear film having directions indicating how to use the tool and where to customize it. One would remove included stylus, being sure this is done on a supported device such as a table or desk, then holding the stylus between ones fingers, like one would hold a pencil, and within the customizable zones 18 indicated on the cards packaging, the user would place the angled straight edge end of the stylus 52 on the cards surface, while applying slight pressure one would move the stylus like one would move a pencil to write, selectively removing the layers needed to create the personalized text, easily creating the desired markings that match the professionally printed text on the card. A short back and forth scratching motion and retracing each mark until achieving desired results may be necessary. Then the sender would place the customizable card in the standard greeting card envelope which the card came with, and the card is ready to give to the intended recipient. The convenience of a customizable professional looking card was created quick and easy without having to order online or figure out any machines, just go to the store purchase and customize on the go.

### Additional Embodiments

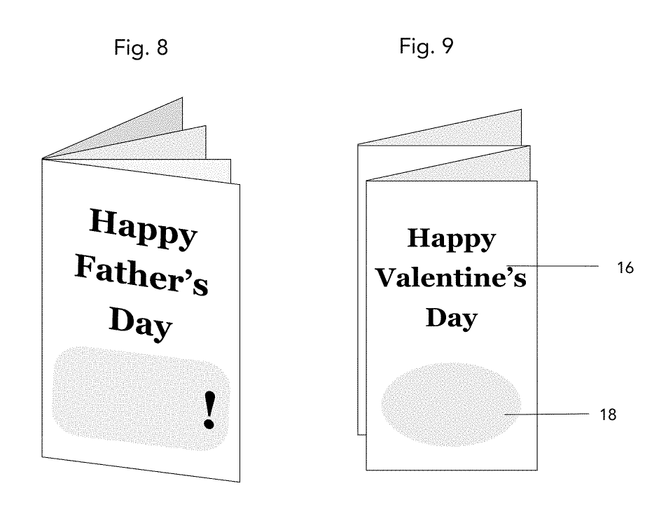

FIG. 8, 9 illustrates the same card in FIGS. 1 and 2 showing a customizable greeting card with alternative structure created using multiple panels and multiple folds.

### Alternative Embodiments

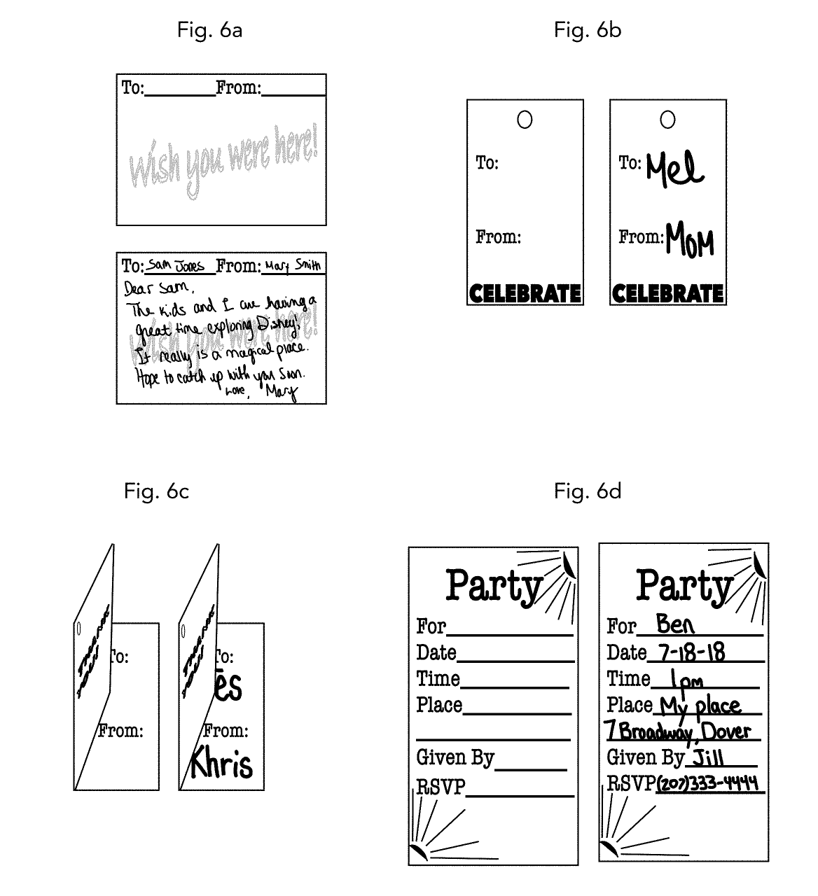

FIG. 6a, 6b, 6c, 6d illustrates various embodiments for incorporating scratch off ink and preprinted text on stationary products for social expression purposes. Examples of before and after are shown to portray the look of the customizable zones before customizing can go unnoticed. It is the medium and design of the underlying layers that contrast with the cards surface layers and provides the look of specialty printed substrate such as foil when revealed to create personalized text.

FIG. 6a shows a post card with to: and from: with zones 18 next to each for adding text. Below is the area accustom to writing message that whole area is scratch off for sender to add text. FIGS. 6d and 6c show one embodiments of gift tags, one a single card and one folded card each with to: and from: with customizable zones 18 for adding text, along with theme text, design or message. 6d shows a typical invitation with preprinted text 16 for the sender to fill out. With customizable zones 18 coinciding next to every preprinted entry space 16 that the sender can easily add the information necessary and achieve professionally printed results with coordinating custom text.

### Advantages

From the description above, a number of advantages of some embodiments of my customizable greeting card become evident:

The advantages are for one or more aspects of the described embodiment:

(a) Incorporating scratch off ink on preprinted greeting cards as a means to add additional content provides endless options, from one mass produced manufactured card.

(b) Same distribution as current greeting cards on the market, the customizable cards will be available in stores and displayed in the same manner yet offer major benefits far surpassing that of standard cards.

(c) Grab and go convenience, makes it easy to customize on the go with everything needed to customize included.

(d) Limitless option for desired personalized names. Add a name one can never find on standard greeting cards and finally give cards addressed to grandparents, displaying the name their family really calls them.

(e) Creates zero waste when all the elements are incorporated into the card no leftover product not used.

(f) Interactive cards are fun and simple to create special cards, personalized to celebrate the receiver.

(g) Cost effective solution for customizable greeting cards when cards are created using printing processes and don't require additional elements or costs of machine, reducing the cost of customizable cards.

(h) Achieve professional results when the scratch off layers coordinate with the preprinted text.

(I) Fill in the blank templates broaden the range for the market it reaches and makes it simple.

(j) Eliminates the need for other cards, therefor minimizing the stock stores must carry.

(k) A kit capable of filling voids in the greeting card market by meeting customers desires to obtain a fully customizable greeting card.

(l) Customizing with this type of card takes up less time when you don't have to spend time ordering online or waiting for your order to be ready.

(m) Customizable cards are ready at a moment's notice and can be kept on hand for last minute needs.

(n) Always grab the perfect card when you enter the information to suit your need.

(o) More of a variety when any age can be added to a card, there are more than one style of card for every age. Minimize giving the recipient the same card as someone else.

### CONCLUSION, RAMIFICATIONS, AND SCOPE

Accordingly, the reader will see that the customizable greeting card of the various embodiments can be used to create a customized greeting card, invitation, postcard, gift tag and the like easily and conveniently. In addition, the incorporation of scratch off ink provides unlimited customizable options creating zero waste.

Furthermore, the customizable greeting card has additional advantages in that it permits the need for conventional writing implements and the need to use personal printers yet provides outstanding results. The ability to add personalized information on the greeting card increases the sending and receiving of greeting cards by allowing the freedom to choose what the card says. It offers more options, it makes finding the right card faster and easier, and gives people the ability to send a card that says what they never find on standard cards, and therefore improves personal relationships.

Although the description above contains many specificities, these should not be construed as limiting the scope of the embodiments but as merely providing illustrations of some of several embodiments. For example, the greeting card can have other shapes such as circular, oval, rectangular etc. The type of substrate used for the card can range from thick paper to assorted card stock or film, mixed materials and media; die-cut windows on panels; multiple panels; lights and sound; incorporate multiple printing methods; the components used to create the customizable zones layers can consist of any type of adequate substance that will produce the desired results; other shapes for the stylus can be included with the card or stylus is sold separately; sticker that provide the same scratch off marking ability to customize cards with a fill in the blanks type of preprinted text as well as protective film or sprays to prevent further scratch off once finished.

Thus, the scope of the embodiment should be determined by the appended claims and their legal equivalents, rather than by examples given. With respect to the above description, it is to be realized that the optimum dimensional relationship for the parts of the customizable greeting card, to include variations in form, size, shape, materials, function, and manner of assembly, operation and use, are deemed readily apparent and obvious to one skilled in the art, and all equivalent relationships to those illustrations in the drawings and described in the specification, are intended to be encompassed by the present invention.

What is claimed is:

1. A greeting card kit, comprising:
a sheet of writable material having a preprinted greeting card portion; wherein on at least one of said portions there is provided a removable layer zone; said removable layer provides the means to enter personalized information, creating a professionally finished customized greeting card.
a. The greeting card kit of claim 1 wherein said removable layer is an opaque matter well-disposed to being scratched away.
b. The greeting card kit of claim 1 wherein said removable layer zone coordinates to said preprinted greeting card portion providing said professionally finished customized card.
c. The greeting card kit of claim 1 wherein said removable layered zone consists of one or more layers.
d. The greeting card kit of claim 1 wherein said having preprinted greeting card portion displays voids in text, providing a fill in the blank type template.
e. The greeting card kit of claim 1 wherein said a sheet of writable material contains contains one or more sheets of said writable material.
f. The greeting card kit of claim 1 wherein said on at least one of said portions there is provided said removable layer zone, removable by means of applying pressure with a hard-edged object.
g. The greeting card kit of claim 1 wherein said removable coating is a scratch off ink substance.
h. The greeting card kit of claim 1 wherein said removable coating is a scratch off ink substance, furthermore includes any ink or material that produces a color change or color reveal by rubbing, scratching, wiping, applying pressure or other heat producing means.

2. A greeting card kit, comprising;
a. a preprinted greeting card;
b. a removable coating layer;
c. a standard envelope;
d. a clear protective packaging; and
e. a wooden stylus.
i. The greeting card kit of claim 2 wherein said a wooden stylus is included.
j. The greeting card kit of claim 2 wherein said wooden stylus is flat like a popsicle stick with a pointed angled flat edge end.
k. The greeting card kit of claim 2 wherein said greeting card kit includes any standard greeting card envelope.
l. The greeting card kit of claim 2 wherein said greeting card kit, a clear protective packaging can include printed matter marked with instructions for use.
m. The greeting card kit of claim 2 further comprising a protective coating or sheet applied after user customizes.

3. A method for customizing social expression card or stationary item comprising:
Attaining a card with desired theme; opening said clear packaging; removing said stylus; holding said stylus the way one would hold a writing implement; using the angled edge end of said stylus; applying slight pressure to cards surface in designated customizable zones; rubbing said stylus pointed angled edge end to selectively remove layers; marking the surface by revealing a contrasting underlying substrate; creating desired text.
a. The method of claim 3 further comprising any hard-edged object to add information without using conventional writing implements.
b. The method of claim 3 further comprising supplied with or without other forms of protective packaging.
